(19) United States
(12) Patent Application Publication
(10) Pub. No.: US 2009/0038823 A1
(43) Pub. Date: Feb. 12, 2009

(54) WIRING SUBSTRATE WITH LEAD PIN AND LEAD PIN

(75) Inventors: Yoshinori Furihata, Nagano-shi (JP); Toshifumi Machii, Nagano-shi (JP); Kiyotaka Shimada, Nagano-shi (JP); Kazuhiro Yoshida, Izumi-shi (JP)

Correspondence Address: RANKIN, HILL & CLARK LLP, 38210 Glenn Avenue, WILLOUGHBY, OH, 44094-7808, US

(73) Assignees: SHINKO ELECTRIC INDUSTRIES CO., LTD., Nagano-shi (JP); NEOMAX MATERIALS CO., LTD., Osaka (JP)

(21) Appl. No.: 12/186,851

(22) Filed: Aug. 6, 2008

(30) Foreign Application Priority Data
Aug. 7, 2007 (JP) 2007-205716

(51) Int. Cl. H01B 5/00

(52) U.S. Cl. 174/126.1

(57) ABSTRACT

A wiring substrate with lead pins formed by bonding lead pins to electrode pads formed on a wiring substrate through conductive materials is provided and in the lead pin, the end face side bonded as opposed to the electrode pad of a head part formed in one end of a shaft part is formed in a conic protrusion part and also a vertex angle of the conic protrusion part is set in an angle range of 110° to 140°, and the conductive material is interposed between the conic protrusion part and the electrode pad and also extends to a flat part of the head part and reaches an outer surface of the shaft part and the lead pin is bonded to the electrode pad.

### TECHNICAL FIELD

The present disclosure relates to a wiring substrate with a lead pin and a lead pin, and more particularly to a pin grid array (PGA) type wiring substrate with lead pins formed by bonding lead pins to electrode pads, and lead pins used in this wiring substrate.

### RELATED ART

A pin grid array type wiring substrate with lead pins includes a product formed by bonding lead pins 5, 6 to electrode pads 12 disposed in a wiring substrate 10 through conductive materials such as conductive materials 14 as shown in FIGS. 11A and 11B. FIG. 11A is an example of bonding the lead pin 5 of the so-called flat pin type whose head part 5a is formed in a flat disk shape, and FIG. 11B is an example of bonding the lead pin 6 in which the bonding surface side of a head part 6a is formed in a spherical surface shape. In both the examples, the lead pins 5, 6 are bonded so that end faces of the head parts 5a, 6a are abutted on the electrode pads 12.

In the case of bonding the lead pins 5, 6 to the wiring substrate 10, the conductive material such as solder is supplied to the electrode pad 12 and by a support jig, the lead pin is supported and the lead pin is aligned with the electrode pad 12 and the wiring substrate 10 is bonded by passing through a reflow apparatus together with the support jig in a state of supporting the lead pin. The lead pin used in the recent wiring substrate with lead pins has extremely thin diameters in which an outside diameter of a shaft part of the pin is 0.3 mm and an outside diameter of the head part is 0.6 to 0.7 mm and the lead pins are arranged at a narrow distance, so that a strength of bonding of the lead pin to the electrode pad and misalignment of inclination etc. of the lead pin in a state of bonding the lead pin to the electrode pad become problems.

The lead pin 6 in which an end face of the head part 6a is formed in the spherical surface shape shown in FIG. 11B has been proposed as a lead pin in which a strength of bonding of the lead pin can be increased as compared with the lead pin 5 of the flat pin and misalignment of the lead pin 6 can be prevented by preventing a void 15 from occurring in the conductive material 14 at the time of bonding (see Patent References 1, 2). Also, a lead pin has been proposed in which a groove is disposed in an end face of a head part of the lead pin of the flat pin type and a strength of bonding of the lead pin is improved and also occurrence of a void in solder is suppressed (see Patent Reference 3).

[Patent Reference 1] Japanese Patent Application Publication No. 2001-217341

[Patent Reference 2] Japanese Patent Application Publication No. 2001-358277

[Patent Reference 3] Japanese Patent Application Publication No. 2006-86283

The reason why a void must be prevented from occurring in solder in the case of bonding a lead pin to an electrode pad is because a problem of decreasing reliability of electrical connection between the lead pin and the electrode pad when the void occurs in the solder and a problem that the lead pin is bonded in a state of being inclined from an erect position due to the void and a height of the tip of the lead pin or a distance between the tips of the lead pins varies as shown in FIG. 11A arise. In the recent wiring substrate with lead pins, an arrangement distance between the lead pins becomes narrow, so that misalignment of the lead pin tends to be directly linked to a product failure.

Also, in a test of a bonding strength of a lead pin, a tensile strength test for performing a test by pulling the lead pin in an oblique direction from an erect position is performed. This is a test in which in the case of inserting and withdrawing a semiconductor package into and from a socket, an operation of applying force to the socket in an oblique direction and pulling out the semiconductor package is assumed and endurance for tensile force in the oblique direction is tested. When the lead pin is pulled in the oblique direction, the tensile force concentrates on a bonding part of the lead pin and destruction of the bonding part tends to occur.

When a diameter of a head part of the lead pin is generally increased, a bonding area of the lead pin increases and a bonding strength increases. However, when the head part is increased, the head part interferes with a socket hole in the case of attaching the semiconductor package to the socket, so that a size of the head part is limited. Therefore, it is necessary to be constructed so as to obtain a required bonding strength without increasing the head part.

The lead pin in which the outer surface of the head part is formed in the spherical surface as mentioned above is constructed so that tensile force acting on the lead pin from an oblique direction is distributed and a bonding strength is increased and a void is made easy to be relieved and a situation in which the void is closed in solder is suppressed. However, this lead pin is also not necessarily sufficient in the respect that occurrence of the void in solder is suppressed and the bonding strength of the lead pin is increased.

### SUMMARY

Exemplary embodiments of the present invention provide a wiring substrate with a lead pin having high reliability by increasing a strength of bonding between the lead pin and an electrode pad and suppressing occurrence of a void in a bonding part, and also provide a lead pin suitably used in this wiring substrate with the lead pin.

The invention comprises the following configurations.

That is, a wiring substrate with a lead pin comprises:

a wiring substrate;

a lead pin bonded to an electrode pad formed on the wiring substrate through a conductive material,

wherein the lead pin includes a shaft part and a heard part formed in a diameter larger than that of the shaft part in one end of the shaft part, an end face side bonded as opposed to the electrode pad of the head part is formed in a conic protrusion part, a vertex angle θ of which is set in an angle range of 110° to 140°, and a shaft part side of the heard part is formed in a flat part and, wherein the conductive material is interposed between the conic protrusion part and the electrode pad and also extends to the flat part of the head part and reaches an outer surface of the shaft part so that the lead pin is bonded to the electrode pad.

In the wiring substrate with the lead pin of the invention, the shaft part side of the heard part is formed in the flat part, and thus, the head part is easy to be formed in manufacture of the lead pin.

Also, a lead pin in which the head part includes the conic protrusion part, and a columnar part formed integrally with the conic protrusion part in a basal part of the conic protrusion part is be used as the lead pin.

Also, a lead pin in which an outside diameter of the head part is 0.45 mm to 0.65 mm is suitably used.

Also, a conductive material made of a tin-antimony alloy as a lead-free conductive material is suitably used as the conductive material.

Also, a lead pin used for a wiring substrate with a lead pin comprises:

a shaft part; and a head part formed in a diameter larger than that of the shaft part in one end of the shaft part,

wherein an end face side to be bonded to the wiring substrate of the head part is formed in a conic protrusion part, and a vertex angle θ of the conic protrusion part is set in an angle range of 110° to 140°.

Also, it is wherein the head part includes the conic protrusion part, and a columnar part formed integrally with the conic protrusion part in a basal part of the conic protrusion part, and also a product in which an outside diameter of the head part is 0.65 mm to 0.45 mm is effectively used.

According to a wiring substrate with a lead pin and a lead pin according to the invention, a strength of bonding between the lead pin and an electrode pad formed on a wiring substrate can be improved and also occurrence of a void in a conductive material for bonding the lead pin to the electrode pad can be suppressed. Therefore, it can be provided as the wiring substrate with the lead pin having high reliability by preventing misalignment of the lead pin or irregularity in a height of the lead pin in the case of bonding the lead pin to the electrode pad.

Other features and advantages may be apparent from the following detailed description, the accompanying drawings and the claims.

### BRIEF DESCRIPTION OF THE DRAWINGS

FIG. 1 is a sectional view showing a configuration of a wiring substrate with lead pins.

FIG. 2A is a plan view and FIG. 2B is a front view of a lead pin according to the invention.

FIG. 3 is an enlarged sectional view showing a state of bonding a lead pin to an electrode pad.

FIG. 4 is a graph showing a result of measuring a strength of bonding between an electrode pad and a lead pin in which a vertex angle θ of a head part is changed.

FIG. 5 is a graph showing a result of measuring a strength of bonding between an electrode pad and a lead pin comprising a conic protrusion part and a lead pin whose head part is formed in a spherical surface.

FIG. 6 is a soft X-ray transmission image of a solder bonding part of a lead pin comprising a conic protrusion part with a vertex angle θ of 130°.

FIG. 7 is a soft X-ray transmission image of a solder bonding part of a lead pin comprising a conic protrusion part with a vertex angle θ of 150°.

FIG. 8 is a soft X-ray transmission image of a solder bonding part of a lead pin comprising a conic protrusion part with a vertex angle θ of 160°.

FIG. 9 is a soft X-ray transmission image of a solder bonding part for a lead pin of a flat pin.

FIG. 10 is a soft X-ray transmission image of a solder bonding part for a lead pin of an R pin.

FIGS. 11A and 11B are sectional views showing a related-art configuration of a wiring substrate with lead pins.

### DETAILED DESCRIPTION

FIG. 1 is a sectional view showing a configuration of one embodiment of a wiring substrate with lead pins according to the invention. In a wiring substrate 30 with lead pins of the present embodiment, an installation part 30a for installing a semiconductor element 40 is disposed on one surface of a wiring substrate 10 and electrode pads 12 are formed on the other surface of the wiring substrate 10 and lead pins 20 are bonded to the electrode pads 12 by conductive materials 14 made of tin-antimony alloys.

A necessary wiring pattern and a pad for connection electrically connected to the semiconductor element 40 are formed in the installation part 30a. The other surface of the wiring substrate 10 is covered with a protective film 16 such as a solder resist, and the electrode pad 12 to which the lead pin 20 is bonded is exposed in a circular plane shape. The electrode pad 12 is formed by a copper layer, and nickel plating and gold plating are given to a surface of the copper layer in this order as protective plating.

In the case of bonding the lead pin 20 to the electrode pad 12, a conductive paste made of a tin-antimony alloy is first applied to an exposed surface of the electrode pad 12 as a conductive material and a head part 20a of the lead pin 20 is aligned with each of the electrode pads 12 and the lead pin 20 is bonded by a reflow step. Concretely, a support jig in which a set hole for setting the lead pin 20 is formed in arrangement matching with plane arrangement of the electrode pad 12 formed on the wiring substrate 10 is used, and the lead pin 20 is set in the support jig, and the lead pin 20 is bonded by passing through a reflow apparatus in a state of aligning the support jig with the wiring substrate 10. The wiring substrate 30 with lead pins shown in FIG. 1 is obtained by removing the support jig after the lead pins 20 are bonded to the electrode pads.

The support jig has action of having support so as to solder the lead pins 20 in a state of erecting the lead pins 20 on a substrate surface of the wiring substrate 10 while aligning the lead pins 20 with the electrode pads 12. The set hole of the lead pin 20 disposed in the support jig is formed in a diameter dimension in which the head part 20a is locked in the case of inserting a shaft part 20b of the lead pin 20. Since there is a clearance between the set hole and the shaft part, when the lead pin 20 is bonded with the lead pin inclined in the case of soldering the lead pin 20, problems that the support jig cannot be removed from the wiring substrate with lead pins or the lead pin 20 is deformed in the case of removing the support jig arise. Therefore, also from the standpoint of a manufacturing step of the wiring substrate with lead pins, it is necessary to be constructed so that the lead pin 20 can be bonded with the lead pin erected in the wiring substrate 10.

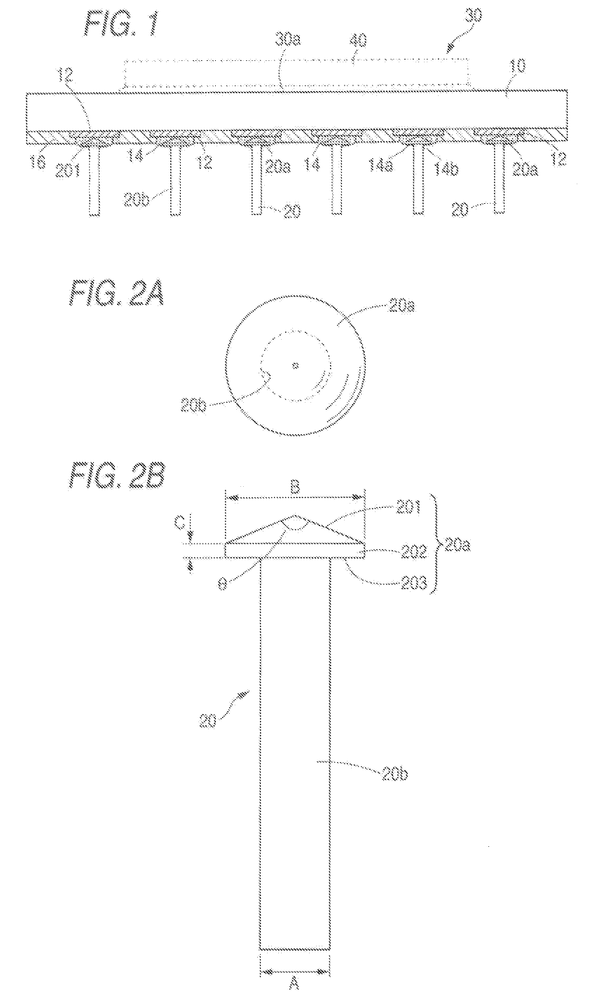

FIGS. 2A and 2B enlarge and show a configuration of the lead pin 20 used in the wiring substrate 30 with lead pins. FIG. 2A is a plan view and FIG. 2B is a front view of the lead pin 20. As shown in FIG. 2B, the lead pin 20 is wherein the head part 20a with a diameter larger than that of the shaft part 20b is formed integrally with the shaft part 20b in one end of the shaft part 20b and the end face side (bonding surface side) bonded to the electrode pad 12 of the head part 20a is formed in a conic protrusion part 201.

In addition, in the lead pin 20 of the embodiment, the portion joined to the shaft part 20b of the head part 20a is formed in a columnar part 202 and in the head part 20a, the columnar part 202 is formed integrally with the conic protrusion part 201. The columnar part 202 can also be formed in the same diameter as that of the outer peripheral edge of the conic protrusion part 201 as described in the embodiment or be formed in a form of overhanging the outer peripheral edge of the columnar part 202 to the outside beyond the outer peripheral edge of the conic protrusion part 201. Also, a form of directly joining the conic protrusion part 201 to the shaft part 20b without disposing the columnar part 202 can be adopted. The side connected to the shaft part 20b of the columnar part 202 is formed in a flat part 203.

A dimension of each part of the lead pin 20 varies depending on a product of the wiring substrate with lead pins, and the lead pin 20 of the embodiment is a product in which an outside diameter A of the shaft part 20b is 0.3 mm and an outside diameter B (outside diameter of the large diameter portion) of the conic protrusion part 201 (head part 20a) is 0.65 mm and a height C of the columnar part 202 is 0.05 mm.

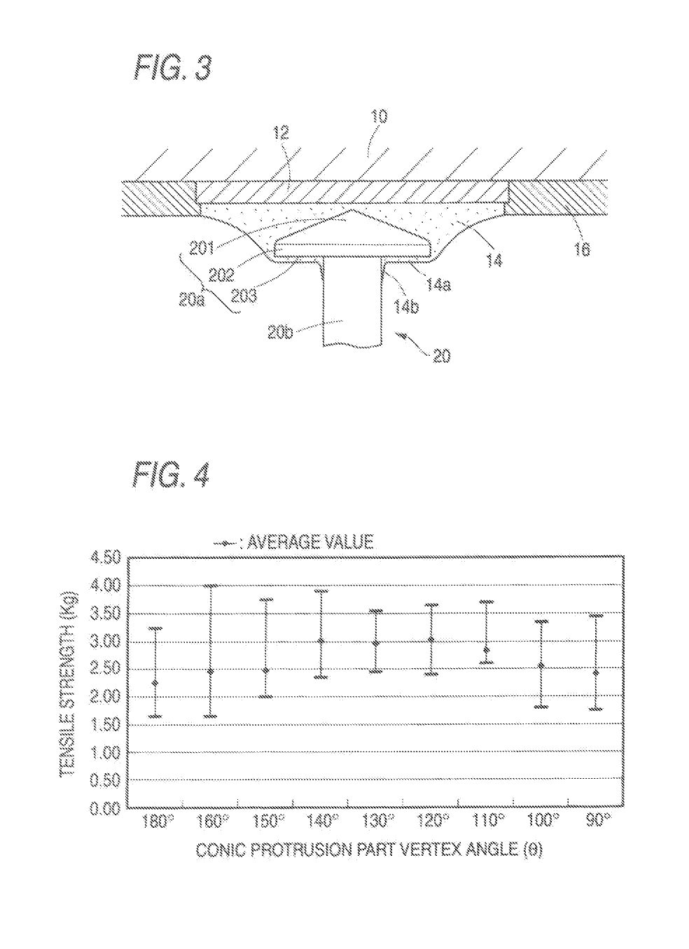

FIG. 3 is an enlarged sectional view showing a state of bonding the lead pin 20 to the electrode pad 12. The head part 20a is opposed to the electrode pad 12 and the lead pin 20 is bonded to the electrode pad 12 by the conductive material 14. A gap between a surface of the electrode pad 12 and the head part 20a of the lead pin 20 is filled with the conductive material 14 and the portion between a peripheral edge part of the electrode pad 12 and a peripheral side surface of the columnar part 202 of the head part 20a is formed in a meniscus shape and further, the conductive material 14 extends to the flat part 203 beyond a peripheral edge part of the columnar part 202 and reaches a basal part of the shaft part 20b of the lead pin 20 and a conductive material 14b thinly adheres to an outer surface of the shaft part 20b.

In order to examine action of the lead pin 20 in which the conic protrusion part 201 is formed in the head part 20a, the present inventor prepared samples in which a vertex angle θ of the conic protrusion part 201 formed in the head part 20a is changed and examined how a bonding strength of the lead pin 20 changes by changing the vertex angle θ.

Table 1 shows results of bonding lead pins to electrode pads and measuring bonding strengths for 9 kinds of lead pins with different vertex angles θ of the conic protrusion parts 201. In the used samples, a diameter of a shaft part is 0.3 mm and an outside diameter of a conic protrusion part is 0.7 mm and a height of a columnar part is 0.02 mm and vertex angles θ of the conic protrusion parts are set at 90°, 100°, 110°, 120°, 130°, 140°, 150°, 160° and 180°.

TABLE 1

| | | Standard | | |
|---|---|---|---|---|
| Vertex angle | Average | deviation | Maximum | Minimum |
| (θ) | value (Kg) | (Kg) | value (Kg) | value (Kg) |
| 180° | 2.33 | 0.40 | 3.25 | 1.66 |
| 160° | 2.43 | 0.46 | 4.00 | 1.62 |
| 150° | 2.48 | 0.26 | 3.26 | 2.00 |
| 140° | 3.02 | 0.34 | 3.9 | 2.33 |
| 130° | 2.98 | 0.43 | 3.54 | 2.43 |
| 120° | 3.05 | 0.40 | 3.65 | 2.40 |
| 110° | 2.83 | 0.46 | 3.69 | 2.59 |
| 100° | 2.55 | 0.44 | 3.33 | 1.80 |
| 90° | 2.42 | 0.4 | 3.44 | 1.74 |

FIG. 4 shows measurement results shown in Table 1 by a graph. In FIG. 4, average values, maximum values and minimum values of tensile strengths of the lead pins are shown.

A bonding strength of the lead pin was measured by pinching a shaft part of the lead pin in a jig for measurement and pulling the lead pin in a direction inclined 30° with respect to a direction (vertical direction) in which the lead pin is erected and measuring tensile force (peak strength: Kg/pin) at the time of breaking a bonding part between the lead pin and the electrode pad. The number of samples used in a test is respectively 30, and Table 1 shows an average value of tensile strengths measured for 30 samples. In addition, tin-antimony (Sn—Sb) alloy solder was used as a conductive material for bonding the lead pin to the electrode pad.

It is apparent from the measurement results of FIG. 4 and Table 1 that the tensile strength of the lead pin changes by the vertex angle θ of the conic protrusion part of the head part and a good tensile strength is obtained in the range in which the vertex angle θ is 110° to 140° and particularly, an excellent tensile strength is obtained in the range in which the vertex angle θ is 120° to 140°.

The reason why the tensile strength improves in the range in which the vertex angle θ of the conic protrusion part is 110° to 140° as compared with a related-art flat pin type lead pin with a vertex angle θ of 180° is probably because by disposing the conic protrusion part 201 in the head part 20a, tensile force does not concentrate on a part of the bonding part and is distributed and the tensile force is eased in the case of pulling the lead pin 20 in an oblique direction.

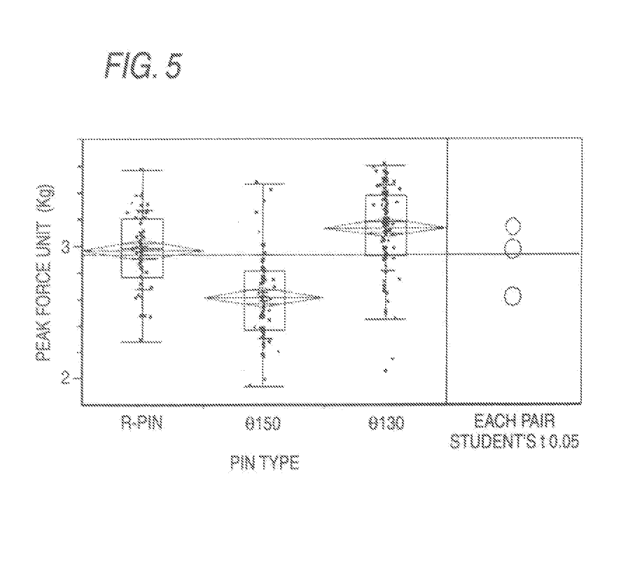

Table 2 and FIG. 5 show results of measuring tensile strengths for other samples (vertex angles θ of 130° and 150°) of lead pins comprising conic protrusion parts as compared with a related-art lead pin (R pin) whose head part is formed in a spherical surface shape.

TABLE 2

| | The | | | | Minimum | Maximum |
|---|---|---|---|---|---|---|
| | number | Average | Standard | Standard | value | value |
| | of | value | deviation | error | (95%) | (95%) |
| | samples | (Kg) | (Kg) | (Kg) | (Kg) | (Kg) |
| R-Pin | 128 | 2.96727 | 0.297937 | 0.02633 | 2.9152 | 3.0194 |
| Cone | 128 | 2.58516 | 0.294263 | 0.02601 | 2.5337 | 2.6366 |
| 150° | | | | | | |
| Cone | 160 | 3.09738 | 0.352357 | 0.02786 | 3.0424 | 3.1524 |
| 130° | | | | | | |

Table 2 and FIG. 5 show that the tensile strength bearing comparison with the related-art R pin is obtained in the lead pin in which the vertex angle θ of the conic protrusion part is set at 130°.

As described above, the wiring substrate with lead pins is inserted into and withdrawn from a socket, so that it is important to increase a bonding strength of the lead pin in order to improve handleability and reliability of a product. Also, in the wiring substrate with lead pins, the lead pin with a thinner diameter is used, so that it is important to adopt a form of a lead pin capable of obtaining a necessary bonding strength also in the lead pin with the thin diameter.

The bonding strength of the lead pin desired in the wiring substrate with lead pins varies depending on a product, and is normally sufficient when a tensile strength of about 2.0 (Kg/pin) is obtained. The bonding strength of the lead pin of the embodiment sufficiently satisfies a necessary condition in the wiring substrate with lead pins, and the lead pin can be suitably used in the wiring substrate with lead pins.

When the head part of the lead pin has a large diameter to a certain extent, a bonding area can be ensured widely even when a flat pin is used as the lead pin, so that it is easy to obtain a necessary bonding strength, but when an outside diameter of the head part becomes about 0.65 mm or less as described in the embodiment, an area of bonding between the lead pin and the electrode pad decreases, so that the bonding strength of the lead pin reduces inevitably. In this respect, the lead pin 20 in which the conic protrusion part 201 is disposed in the head part 20a of the embodiment is probably effective in improving the bonding strength. In addition, a configuration of the lead pin in which the conic protrusion part is disposed in the head part of the invention of the present application can be effectively applied in the range in which the outside diameter of the head part is about 0.45 mm to 0.65 mm.

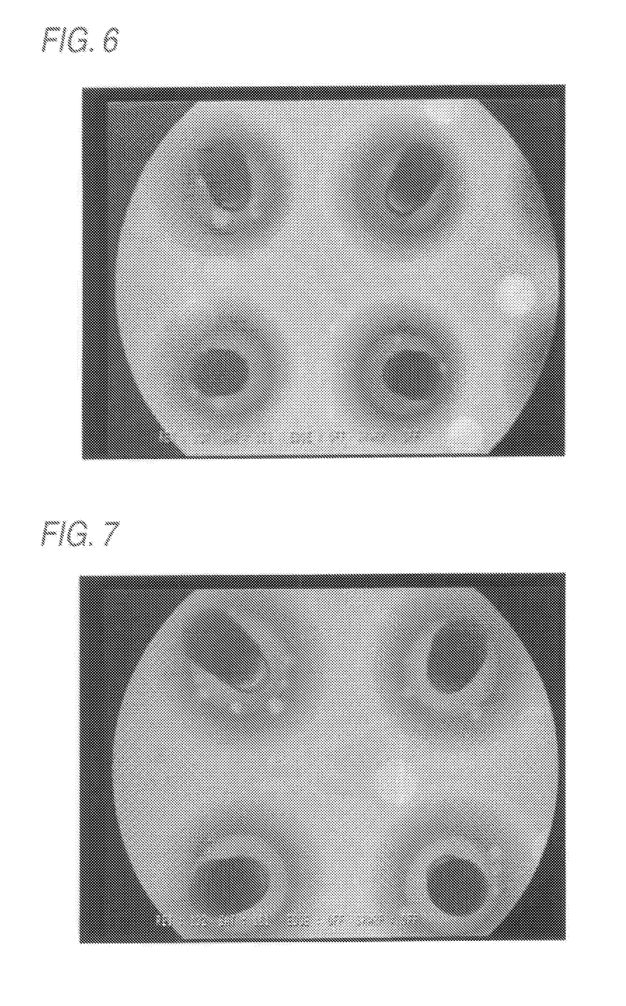

FIGS. 6 to 9 show results of examining a void occurring in solder in the case of bonding a lead pin to an electrode pad. When the lead pin is soldered to the electrode pad, occurrence of a void in solder for bonding a head part of the lead pin to the electrode pad is often seen. This void decreases reliability of electrical connection between the head part and the electrode pad and the lead pin is bonded in a state of floating from a surface of the electrode pad, so that problems that heights of the tips of the lead pins become irregular or the lead pin is bonded in a state of being inclined from an erect position are caused.

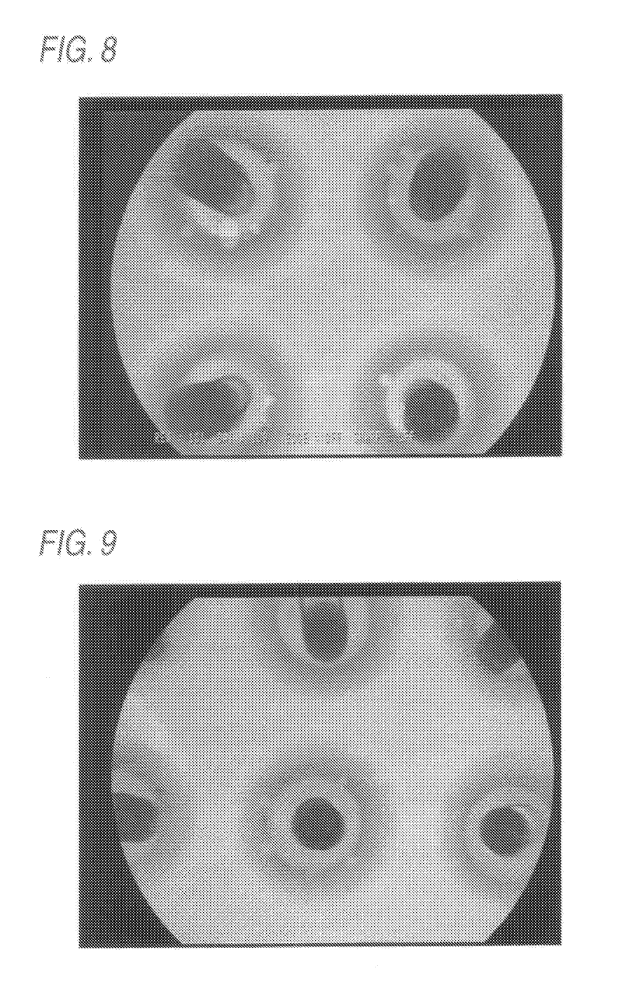

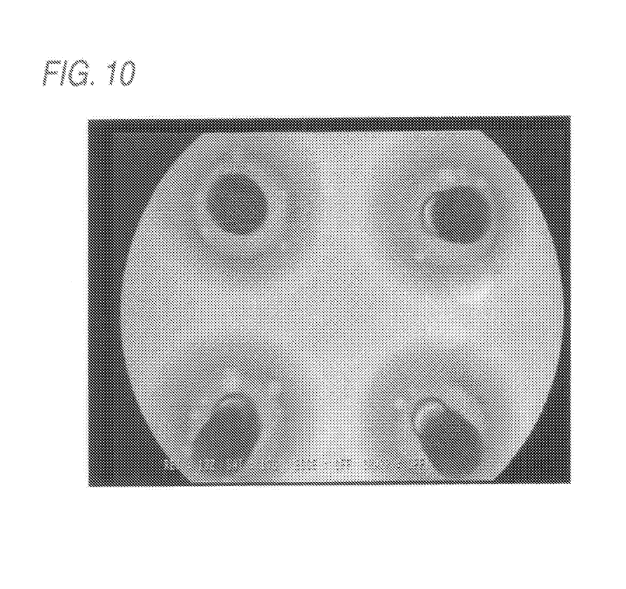

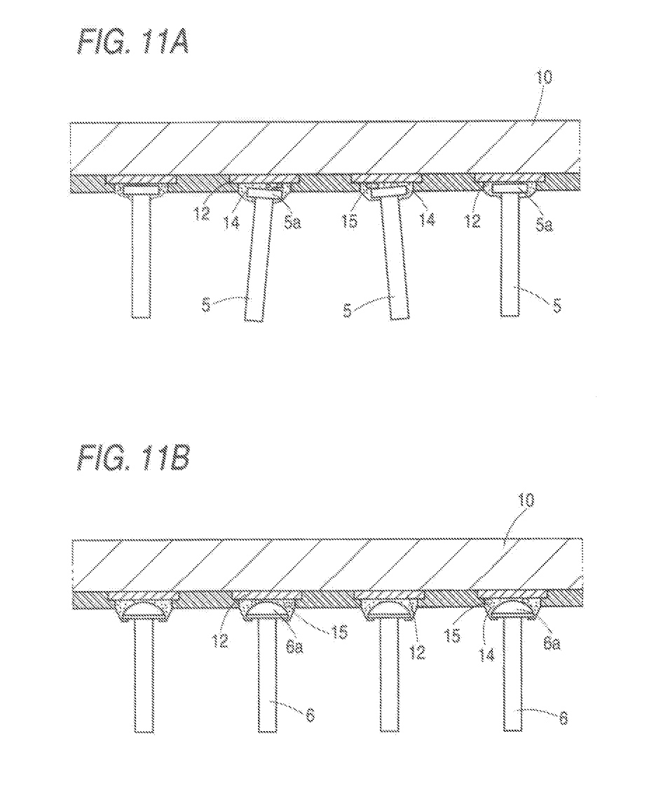

FIGS. 6 to 9 show a state of viewing a bonding part between the lead pin and the electrode pad as a soft X-ray transmission image in order to observe a state of a void occurring in the bonding part between the lead pin and the electrode pad. FIG. 6 is an example of setting a vertex angle θ of a conic protrusion part at 130° in a lead pin in which the conic protrusion part is formed in a head part, and FIG. 7 is an example of setting a vertex angle θ of the conic protrusion part at 150°, and FIG. 8 is an example of setting a vertex angle θ of the conic protrusion part at 160°. FIG. 9 is a soft X-ray transmission image for a flat pin, and FIG. 10 is a soft X-ray transmission image for an R pin whose head part is formed in a spherical surface. In addition, the portion appearing as a black point is a shaft part of the lead pin and voids occurring in solder appear as white circular points.

As shown in FIG. 10, relatively large voids are observed also in the case of soldering using the R pin for probably suppressing occurrence of the voids. Similarly, occurrence of voids in the soldered portion is observed in the case of the flat pin shown in FIG. 9.

Also in the case (FIGS. 6 to 7) of using the lead pins in which the conic protrusion part is formed in the head part, occurrence of voids in solder is observed. However, it is found that the number of occurrences of voids decreases and a size of the void also becomes smaller in the case of the vertex angle θ of 130° shown in FIG. 6 as compared with the case of the vertex angle θ of 150° shown in FIG. 7 and the case of the vertex angle θ of 160° shown in FIG. 8 among the lead pins in which the conic protrusion part is formed.

In the case of comparing states of occurrence of the voids shown in FIGS. 6 to 9, the lead pin in which the conic protrusion part whose vertex angle θ shown in FIG. 6 is set at 130° is disposed can have action of suppressing occurrence of the voids stronger than the lead pins with vertex angles θ larger than 130°. This is probably because the voids occurring in solder become resistant to being relieved to the outside since an end face of the head part opposed to the electrode pad becomes close to a flat surface when the vertex angle θ is increased. On the other hand, in the example (vertex angle θ: 130°) shown in FIG. 6, an angle of the conic protrusion part becomes steep, so that the voids occurring in solder become easy to be relieved from the head part to the outside and this probably suppresses a situation in which the voids occur or remain in the solder bonding part. Also in the case of the R pin whose head part is formed in the spherical surface, an end face opposed to the electrode pad becomes flat in the vicinity of the top part, so that the voids probably becomes easy to remain by suppressing action of relieving the voids from the inside of solder.

The lead pin according to the invention is wherein the conic protrusion part is formed in the end face opposed to the electrode pad of the head part and also the vertex angle θ of the conic protrusion part is set at angles of 110° to 140°, for example, an angle steeper than 130° or at angles of the vicinity of 130° and thereby, occurrence of a void in solder for bonding the lead pin to the electrode pad can be suppressed and situations in which height positions of the tips of the lead pins bonded to the electrode pads vary or the lead pin is bonded with the lead pin inclined can be prevented.

Also, the lead pin according to the invention can obtain a strength of bonding to the electrode pad more than or equal to that of the related-art R pin as described above, so that it can be suitably used as the lead pin used in the wiring substrate with lead pins together with an effect of suppressing the void.

In addition, in the embodiment described above, the experiment has been performed using the lead pin in which a copper material is used as a base material and nickel plating and gold plating are given to a pin surface, but proper materials can be selected as the lead pin and also plating given to the pin surface can be selected properly.

Also, in the embodiment described above, the tin-antimony alloy solder has been used as the conductive material for bonding the lead pin to the electrode pad. The tin-antimony alloy solder is suitably used as lead-free solder, but in the invention, a kind of conductive material for bonding the lead pin to the electrode pad is not particularly limited.

Also, in the lead pin according to the invention, the conic protrusion part is formed in the head part. Since the head part is formed by press processing in a manufacturing step of the lead pin, it is easy to perform processing so as to form the conic protrusion part in the head part in the case of the press processing and there is also an advantage that productivity of the lead pin is not decreased.

1. A wiring substrate with a lead pin, comprising:
a wiring substrate;
a lead pin bonded to an electrode pad formed on the wiring substrate through a conductive material,
wherein the lead pin includes a shaft part and a head part formed in a diameter larger than that of the shaft part in one end of the shaft part, an end face side bonded as opposed to the electrode pad of the head part is formed in a conic protrusion part, a vertex angle θ of which is set in an angle range of 110° to 140°, and a shaft part side of the head part is formed in a flat part and,
wherein the conductive material is interposed between the conic protrusion part and the electrode pad and also extends to the flat part of the head part and reaches an outer surface of the shaft part so that the lead pin is bonded to the electrode pad.

2. A wiring substrate with a lead pin as claimed in claim 1, wherein the head part includes the conic protrusion part, and a columnar part formed integrally with the conic protrusion part in a basal part of the conic protrusion part.

3. A wiring substrate with a lead pin as claimed in claim 1, wherein an outside diameter of a large diameter portion of the conic protrusion part of the head part is 0.45 mm to 0.65 mm.

4. A wiring substrate with a lead pin as claimed in claim 1, wherein the conductive material is made of a tin-antimony alloy.

5. A lead pin used for a wiring substrate with a lead pin, comprising:
a shaft part; and
a head part formed in a diameter larger than that of the shaft part in one end of the shaft part,
wherein an end face side to be bonded to the wiring substrate of the head part is formed in a conic protrusion part, and a vertex angle θ of the conic protrusion part is set in an angle range of 110° to 140°.

6. A lead pin as claimed in claim 5, wherein the head part includes the conic protrusion part, and a columnar part formed integrally with the conic protrusion part in a basal part of the conic protrusion part.

7. A lead pin as claimed in claim 5, wherein an outside diameter of a large diameter portion of the conic protrusion part of the head part is 0.45 mm to 0.65 mm.

8. A lead pin as claimed in claim 6, wherein an outside diameter of a large diameter portion of the conic protrusion part of the head part is 0.45 mm to 0.65 mm.
